(19) United States
(12) Patent Application Publication
(10) Pub. No.: US 2009/0264551 A1
(43) Pub. Date: Oct. 22, 2009

(54) Photocurable fixture for orthopedic surgery background of the invention

(75) Inventors: Nobuyasu Nakasugi, Kyoto-Shi (JP); Hiroshi Yamaguchi, Mito-shi (JP)

Correspondence Address: BRUCE L. ADAMS, ESQ., ADAMS & WILKS, 17 Battery Place-Suite 1231, New York, NY, 10004, US

(73) Assignee: Alcare Co., Ltd.

(21) Appl. No.: 12/386,516

(22) Filed: Apr. 17, 2009

(30) Foreign Application Priority Data
Apr. 18, 2008 (JP) 2008-108865
Mar. 9, 2009 (JP) 2009-054650

(51) Int. Cl. C08J 3/28

(52) U.S. Cl. 522/36; 522/90; 522/97; 522/66; 522/63

(57) ABSTRACT

A fixture for orthopedic surgery comprises a photocurable resin containing a urethane type (meth)acrylic acid derivative oligomer obtainable by a polyisocyanate having at least three isocyanate group, and a (meth)acrylic acid derivative having an active hydrogen group; and a photopolymerization initiator which absorbs light of 400 to 700 nm. The photocurable resin is retained in a base material to form a support material. The inner side of the support material is covered with a buffer material and the outer side thereof is covered with a cover material to obtain a splint material as a fixture for orthopedic surgery. The buffer material side of the splint material is put on an affected part of the body and a bandage is wound over it, and then molding is carried out using irradiation with visible light to cure the photocurable resin. As the curing proceeds, a splint is obtained for fixing and supporting the affected part.

### BACKGROUND OF THE INVENTION

1. Field of the Invention

The present invention relates generally to a fixture for orthopedic surgery for forming a splint, cast, stay, etc. which fixes or supports affected or diseased parts for treatment or protection in the fields of medical care or sports. More particularly, the invention relates to a photocurable fixture for orthopedic surgery for treatment or prevention of fracture, sprain, correction, etc. of humans or animals, and for protection of bodies from stumble, shock, etc. in sports, etc.

2. Description of the Related Art

As a surgical bandage used for treatment of fractures or fixtures of parts of the body, ones having plaster of Paris retained in a fiber base material, such as gauze, have been employed for hundreds of years. However, such a surgical bandage has drawbacks such that it is heavy, insufficient in strength, and less in water resistant, and does not allow X-rays to pass through it.

As a method for solving such problems, bandages having a water-curable urethane prepolymer impregnated into a base material of fabric or knit of, for example, glass fibers have been employed as a fixture for orthopedic surgery. Further, a bandage having such a water-curable resin retained in a base material can be wrapped with a covering material and used as a splint material.

A fixture for orthopedic surgery using such water-curable resins is highly water resistant and has a high strength. Further, since X-rays pass through these water-curable resins, X-ray photography can be performed with the fixture attached, and such fixtures have been widely used.

A drawback of these fixtures, however, is that the water-curable resin must be soaked with water, such as by dipping the whole fixture in water stored in a bucket or the like, in order to facilitate a smooth and satisfactory curing reaction. Accordingly, such fixtures cannot be used in the absence of water, thereby making them inconvenient to use. Further, since a cast padding of a cast material or a cover at the skin side of the splint material is soaked with water, the affected part to which the fixture is applied gets wet, which results in an unpleasant feeling to the wearer. Further, when the affected part is required to be fixed immediately after surgery, it may sometimes be impossible to use this fixture in a germ-free condition.

On the other hand, it has been proposed to impregnate a photocurable resin into woven fabric of, for example, glass fibers, and cure it with light. As such photocurable resin, it was at first proposed to use an ultraviolet curable resin (Document 1: JP-B-48-6116). It was then proposed to use a visible light curable resin (Document 2: JP-A-4-8367).

Despite such proposals, fixtures for orthopedic surgery using photocurable resins have not been used in practice for the following reasons. These photocurable resin compositions require an intense light or irradiation for a long time, which sometimes requires a large-sized irradiation machine that may not be readily available. Further, a photopolymerization initiator may sometimes be required in a relatively large amount. Furthermore, some components of such resin compositions have a strong odor or are highly skin stimulative and, therefore, are inappropriate for this purpose. Moreover, there are problems of insufficient storage stability and insufficient strength for such resin compositions.

Another drawback is radical polymerization that occurs in photo-curing, wherein polymerization is inhibited by oxygen in the air, and unreacted components remain on the surface of the cured product to give tackiness.

The visible light-curable fixtures for orthopedic surgery heretofore employed use a urethane(meth)acrylate. This urethane(meth)acrylate is obtained by adding a (meth)acrylate having a hydroxy group to a urethane prepolymer derived from a polyol and isocyanate.

Further, as the photopolymerization initiator used for the photocurable resin of a visible light-curable type, one containing camphorquinone has been used.

A fixture for orthopedic surgery is required to exhibit a high strength and a high hardness of the cured product since it fixes and supports the affected parts. For this purpose, it is required to cure photocurable resins laminated in a multi-layer form and further conduct the curing in air. Further, the photocurable resin is required to have a composition that shows desired performance even if polymerization is inhibited by oxygen in the air.

### SUMMARY OF THE INVENTION

The present invention provides a photocurable fixture for orthopedic surgery which overcomes the foregoing drawbacks, exhibits the desired strength in a short period of time by only irradiation with visible light, generates no unpleasant odor, can easily be used, and can be readily produced.

The assignee of the present application has developed a photocurable fixture for orthopedic surgery, which comprises a base material, and a photocurable resin containing a urethane(meth)acrylate oligomer obtainable from an acrylate and a diisocyanate compound having two isocyanate groups, and a photopolymerization initiator which absorbs light within a wavelength range of 400 to 700 nm, retained in the base material (WO 2006/090605). The present invention has been made to improve this photocurable fixture to obtain such properties that an adequate cured condition can be obtained in a relatively short period.

The present inventors have conducted extensive studies to solve the above-mentioned drawbacks and problems and have found that a photocurable fixture for orthopedic surgery having the desired properties can be obtained by a fixture which comprises a base material; and a photocurable resin retained in the base material and containing a urethane type (meth)acrylic acid derivative oligomer obtainable by a polyisocyanate having at least three isocyanate groups (hereinafter referred to as polyisocyanate) and a (meth)acrylic acid derivative having an active hydrogen group, and a photopolymerization initiator which absorbs light within a wavelength range of 400 to 700 nm.

The urethane type (meth)acrylic acid derivative oligomer may be represented by the following formula I:

A(-NH—CO—X—Y)ₚ (I)

wherein A denotes a polyisocyanate residue, X denotes O, S or NR (R is hydrogen or a C₁₋₈ alkyl group), Y denotes a (meth)acrylic acid derivative residue having an active hydrogen group, and p denotes an integer of at least 3.

As the compound of the formula (I), it is preferred to use a compound wherein at least 40 mol % of Y is a (meth)acrylate having a hydroxy group as an active hydrogen group, represented by the following formula (II):

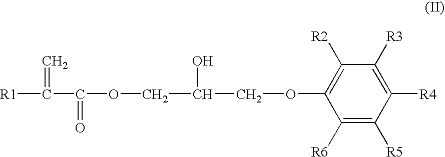

wherein each of R1 to R6 denotes a hydrogen atom or a methyl group.

Further, by using a bisacylphosphine oxide type photopolymerization initiator represented by the following formula (III) as the photopolymerization initiator, an excellent photocurable fixture for orthopedic surgery can be obtained:

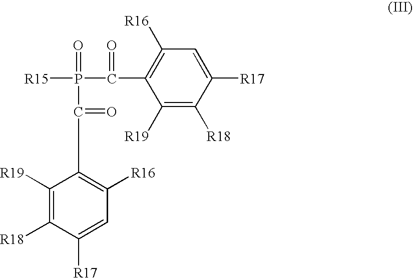

wherein R15 denotes a straight chain or branched chain C₁₋₁₂ alkyl group, a cycloalkyl group, an aryl group which may be substituted by a straight chain or branched chain C₁₋₁₂ alkyl group or a halogen atom; each of R16 and R17, which may be the same or different, denotes a hydrogen atom, a straight chain or branched chain C₁₋₁₂ alkyl group, or a straight chain or branched chain C₁₋₁₂ alkoxy group; and each of R18 and R19, which may be the same or different, denotes a hydrogen atom, or a straight chain or branched chain C₁₋₁₂ alkyl group.

Further, by using a bis(2,4,6-trimethylbenzoyl)phenylphospohine oxide as the photopolymerization initiator of the formula (III), a further preferred photocurable fixture for orthopedic surgery can be obtained.

Moreover, as the photopolymerization initiator, a titanocene type photopolymerization initiator represented by the following formula (IV) may be used:

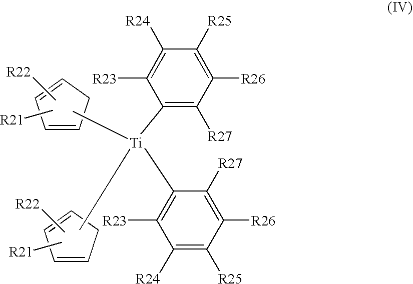

wherein each of R21 and R22 independently denotes a hydrogen atom or a methyl group; R23 denotes a fluorine atom, —CF₃ or —CF₂CH₃; and each of R24, R25, R26 and R27 independently denotes a hydrogen atom, a fluorine atom, —CF₃, —CF₂CH₃, a C₁-C₁₂ alkyl group or alkoxy group, a 6-membered carbocyclic aromatic group, or a 5- or 6-membered heterocyclic aromatic group.

Further, by using bis(cyclopentadienyl)-bis(2,6-difluoro-3-(pyrrol-1-yl)phenyl)titanium as the photopolymerization initiator of the formula (IV), a preferred photocurable fixture for orthopedic surgery can be obtained.

In accordance with the present invention, it is possible to obtain a photocurable fixture for orthopedic surgery which shows necessary strength in a short period of time by applying visible light. Further, under the light at the level of general lighting from the ceiling in a room, the fixture allows a working period of approximately 2 minutes (i.e., the time within which the fixture for orthopedic surgery can be applied in a formable fashion to affected parts). Accordingly, when the fixture is applied to affected parts, a sufficient working period can be obtained to fix it appropriately.

Further, since water is not used for curing, no stain due to water is seen in surgical operation. Furthermore, the fixture can be used effectively with visible light even in treatment of fractures, etc. at the site in which water cannot be readily prepared, for example, disaster areas or deserts. Particularly, in a case where the fixing function in a sterile condition is required after operation, the fixture is very effective since contamination due to the use of water can be prevented.

### BRIEF DESCRIPTION OF THE DRAWINGS

FIG. 1 is a partially cutaway perspective view showing an example of a photocurable fixture according to the present invention.

FIG. 2 is a partially cutaway perspective view showing another example of a photocurable fixture according to the present invention.

FIG. 3 is an explanatory view of a flexural strength test apparatus used in testing fixtures.

### DETAILED DESCRIPTION OF THE INVENTION

Hereinafter, the present invention will be explained in detail with reference to the drawings.

The urethane type (meth)acrylic acid derivative oligomer is obtained by a reaction of polyisocyanate having at least three isocyanate groups with a (meth)acrylic acid derivative having an active hydrogen group.

As the polyisocyanate used in the present invention, an aromatic triisocyanate includes, for example, 1,3,5-triisocyanatomethylbenzene, 4,4′-diphenylmethane triisocyanate, biphenyl-2,4,4′-triisocyanate, 1-methylbenzene-2,4,6-triisocyanate, naphthalene-1,3,7-triisocyanate, triphenylmethane triisocyanate, tris-(p-isocyanatophenyl)thiophosphite, 4,4′-diphenylmethane triisocyanate, diisocyanato-methylbenzyl-cyclohexyl-isocyanate, triisocyanato-methyl-diphenylmethane, and an adduct of trimethylolpropane with 2,4-toluylenediisocyanate.

Further, a polyisocyanate compound as the polymer of the above-mentioned triisocyanate compounds; a modified polyisocyanate compound obtainable by reacting the polyisocyanate compound with a polyhydric alcohol such as trimethylolpropane, glycerol or pentaerythritol; a water-dispersible modified polyisocyanate compound obtainable by introducing a nonionic hydrophilic group such as polyethylene glycol into the polyisocyanate compound; and the like, may be used.

Furthermore, as an aromatic polyisocyanate, for example, an aromatic triisocyanate such as polymeric MDI, triphenylmethane-4,4′,4′;-triisocyanate, 1,3,5-triisocyanatobenzene or 2,4,6-triisocyanatotoluene; a trimer such as 4,4′-diphenylmethane-2,2′,5,5′-tetraisocyanate, polymethylenepolyphenyl isocyanate, and tolylene diisocyanate; and the like, may be used.

Moreover, as an aliphatic triisocyanate, for example, bicycloheptane triisocyanate, lysine ester triisocyanate (such as 2-isocyanatoethyl-2,6-diisocyanatocaproate), 1,6,11-undecane triisocyanate, 1,8-diisocyanato-4-isocyanatomethyloctane, 1,3,6-hexamethylene triisocyanate, an adduct of trimethylolpropane with 1,6-hexamethylenediisocyanate, a modified product of an aliphatic diisocyanate with isocyanurate, 2,5,7-trimethyl-1,8-diisocyanato-5-isocyanate methyloctane, and the like, may be used.

Further, a polyisocyanate compound as a polymer of the triisocyanate compound; a modified polyisocyanate compound obtainable by reacting the polyisocyanate compound with a polyhydric alcohol such as trimethylolpropane, glycerol or pentaerythritol; a water-dispersible modified polyisocyanate compound obtainable by introducing a nonionic hydrophilic group such as polyethylene glycol into the polyisocyanate compound; and the like, may be used.

As an alicyclic triisocyanate, for example, 1,3,5-triisocyanatocyclohexane, 1,3,5-trimethylisocyanatocyclohexane, bicycloheptane triisocyanate, 2-(3-isocyanatopropyl)-2,5-di(isocyanatomethyl)-bicyclo(2,2,1)heptane, 2-(3-isocyanatopropyl)-2,6-di(isocyanatomethyl)-bicyclo(2,2,1)heptane, 3-(3-isocyanatopropyl)-2,5-di(isocyanatomethyl)-bicyclo(2,2,1)heptane, 5-(2-isocyanatoethyl)-2-isocyanatomethyl)-3-(3-isocyanatopropyl)-bicyclo(2,2,1)heptane, 6-(2-isocyanatoethyl)-2-isocyanatomethyl-3-(3-isocyanatopropyl)-bicyclo(2,2,1)heptane, 5-(2-isocyanatoethyl)-2-isocyanatomethyl-2-(3-isocyanatopropyl)-bicyclo(2,2,1)-heptane, 6-(2-isocyanatoethyl)-2-isocyanatomethyl-2-(3-isocyanatopropyl)-bicyclo(2,2,1)heptane, and the like, may be used.

Further, for example, an aromatic diisocyanate such as 2,4-tolylenediisocyanate, 2,6-tolylenediisocyanate, 4,4′-diphenylmethanediisocyanate, 2,4′-diphenylmethanediisocyanate or p-phenylenediisocyanate; an aliphatic diisocyanate such as hexamethylenediisocyanate; an alicyclic diisocyanate such as 3-isocyanatomethyl-3,5,5-trimethylcyclohexylisocyanate or 4,4′-dicyclohexylmethanediisocyanate; an aryl aliphatic diisocyanate such as xylylene diisocyanate; and polyisocyanate having an urethodione structure obtained by cyclodimerization by bonding isocyanate groups each other, such as the above triisocyanates, may be used.

Furthermore, a polyisocyanate having an isocyanurate structure obtained by cyclotrimerization by bonding isocyanate groups to each other, such as the above diisocyanates or triisocyanates; a polyisocyanate having a biuret structure obtained by reacting the above diisocyanates or triisocyanates with water; a polyisocyanate having an oxadiazine trion structure obtained by reacting the above diisocyanates or triisocyanates with carbon dioxide; a polyisocyanate having an alophanate structure; and the like may be used.

The above-mentioned polyisocyanates may be used singly or in combination of at least two. Further, such polyisocyanate and diisocyanate may be used in combination.

Preferred are an aliphatic polyisocyanate and an alicyclic polyisocyanate, and a combination thereof with an aliphatic diisocyanate and an alicyclic diisocyanate. As the diisocyanate to be used in combination, particularly preferred is hexamethylene diisocyanate.

In the (meth)acrylic acid derivative having an active hydrogen group, as the active hydrogen group, a hydroxy group, an amino group, a mercapto group or the like which is capable of reacting with an isocyanate group, may be used; and as the (meth)acrylic acid derivative, a (meth)acrylate, a (meth)acrylamide or the like may be used.

The (meth)acrylate having a hydroxy group may, for example, be a hydroxyalkyl (meth)acrylate such as 2-hydroxyethyl(meth)acrylate, 2-hydroxypropyl(meth)acrylate, 3-hydroxypropyl(meth)acrylate, pentanediol mono(meth)acrylate, hexanediol mono(meth)acrylate or neopentyl glycol mono(meth)acrylate, 2-hydroxyalkyl(meth)acryloyl phosphate, 4-hydroxycyclohexyl(meth)acrylate, trimethylolpropane di(meth)acrylate, pentaerythritol tri(meth)acrylate and 3-methacryloyloxy-2-hydroxypropyl(meth)acrylate.

Further, a compound produced by an addition reaction of a glycidyl group- or epoxy group-containing compound with a (meth)acrylic acid may, for example, be used. The glycidyl group- or epoxy group-containing compound may, for example, be phenyl glycidyl ether, 2-methylphenyl glycidyl ether, 3-methylphenyl glycidyl ether, 4-methylphenyl glycidyl ether, 2,4-dimethylphenyl glycidyl ether, 2,6-dimethyl glycidyl ether, 2,4,6-trimethyl glycidyl ether, butyl glycidyl ether and glycidyl(meth)acrylate.

These (meth)acrylate derivatives having an active hydrogen group may be used singly or in combination of at least two.

Preferred (meth)acrylate having a hydroxy group is a compound produced by an addition reaction of a glycidyl group- or epoxy group-containing compound with a (meth)acrylic acid, and particularly preferred one is a (meth)acrylic acid addition reaction product of phenyl glycidyl ether.

The acrylate having an amino group may, for example, be an aminoalkyl(meth)acrylate such as 2-aminoethyl(meth)acrylate, 2-aminopropyl(meth)acrylate, 3-aminopropyl(meth)acrylate, 5-aminopentyl(meth)acrylate, 6-aminohexyl(meth)acrylate, 2-aminoalkyl(meth)acryloyl phosphate, 4-aminocyclohexyl(meth)acrylate or 3-methacryloyloxy-2-aminopropyl(meth)acrylate; and an alkylaminoalkyl(meth)acrylate such as 2-methylaminoethyl(meth)acrylate, 2-ethylaminoethyl(meth)acrylate, 2-methylaminopropyl(meth)acrylate, 3-methylaminopropyl(meth)acrylate, 5-methylaminopentyl(meth)acrylate, 6-methylaminohexyl(meth)acrylate, 2-methylaminoalkyl(meth)acryloyl phosphate, 4-methylaminocyclohexyl(meth)acrylate and 3-methacryloyloxy-2-methylaminopropyl(meth)acrylate.

The acrylate having a mercapto group may, for example, be a mercaptoalkyl(meth)acrylate such as 2-mercaptoethyl(meth)acrylate, 2-mercaptopropyl(meth)acrylate, 3-mercaptopropyl(meth)acrylate, 5-mercaptopentyl(meth)acrylate, 6-mercaptohexyl(meth)acrylate, a 2-mercaptoalkyl(meth)acryloyl phosphate, 4-mercaptocyclohexyl(meth)acrylate and 3-methacryloyloxy-2-mercaptopropyl(meth)acrylate.

The acrylamide having a hydroxy group may, for example, be a hydroxyalkyl (meth)acrylamide such as 2-hydroxyethyl (meth)acrylamide, 2-hydroxypropyl(meth)acrylamide, 3-hydroxypropyl(meth)acrylamide, pentanediol mono(meth)acrylamide, hexanediol mono(meth)acrylamide, neopentyl glycol mono(meth)acrylamide, 4-hydroxycyclohexyl(meth)acrylamide, trimethylolpropane di(meth)acrylamide, pentaerythritol tri(meth)acrylamide and 3-methacryloyloxy-2-hydroxypropyl(meth)acrylamide.

The acrylamide having an amino group may, for example, be an aminoalkyl(meth)acrylamide such as 2-aminoethyl(meth)acrylamide, 2-aminopropyl(meth)acrylamide, 3-aminopropyl(meth)acrylamide, 5-aminopentyl(meth)acrylamide, 6-aminohexyl(meth)acrylamide, 2-aminoalkyl(meth)acryloyl phosphate, 4-aminocyclohexyl(meth)acrylamide and 3-methacryloyloxy-2-aminopropyl(meth)acrylamide; and an alkylaminoalkyl(meth)acrylamide such as 2-methylaminoethyl(meth)acrylamide, 2-ethylaminoethyl(meth)acrylamide, 2-methylaminopropyl(meth)acrylamide, 3-methylaminopropyl(meth)acrylamide, 5-methylaminopentyl(meth)acrylamide, 6-methylaminohexyl(meth)acrylamide, 4-methylaminocyclohexyl(meth)acrylamide and 3-methacryloyloxy-2-methylaminopropyl(meth)acrylamide.

The acrylamide having a mercapto group may, for example, be a mercaptoalkyl(meth)acrylamide such as 2-mercaptoethyl(meth)acrylamide, 2-mercaptopropyl(meth)acrylamide, 3-mercaptopropyl(meth)acrylamide, 5-mercaptopentyl(meth)acrylamide, 6-mercaptohexyl(meth)acrylamide, 4-mercaptocyclohexyl(meth)acrylamide and 3-methacryloyloxy-2-mercaptopropyl(meth)acrylamide.

The urethane type (meth)acrylic acid derivative oligomer may be obtained by reacting 0.8 to 1.2 equivalent amount of isocyanate with one equivalent amount of a (meth)acrylic acid derivative having an active hydrogen group (a —NH₂ group is one equivalent amount).

Reaction methods of these components are not particularly limited, but in general, respective components are mixed at once and reacted at 20 to 120° C. Further, the reaction may be carried out by dividing either one of the isocyanate and the (meth)acrylic acid derivative having an active hydrogen group.

In such a urethane formation reaction, well-known metal catalysts and amine type catalysts may be used.

A preferred urethane type (meth)acrylic acid derivative oligomer is one containing a (meth)acrylate having a hydroxy group of the formula (II) in an amount of at least 40 mol % of the total (meth)acrylates having a hydroxy group.

In the photocurable resin of the present invention, a urethane(meth)acrylate oligomer other than the above-mentioned ones (hereinafter referred to as urethane(meth)acrylate oligomer (B)), and an ethylenic unsaturated compound may be used in combination. The urethane(meth)acrylate oligomer (B) may be obtained by a urethane formation reaction of polyisocyanate, polyol and a (meth)acrylate having a hydroxy group.

As the polyisocyanate used for the urethane formation reaction, in addition to the above diisocyanates, carbodiimide-modified or isocyanurate-modified polyisocyanate thereof may be used. These may be used singly or in combination of at least two.

As the polyol, a low molecular weight polyol such as ethylene glycol, propylene glycol or glycerol may be mentioned. Further, a polyether polyol obtained by adding an alkylene oxide such as ethylene oxide or propylene oxide, to a polyphenol such as hydroquinone or bisphenol A; an amine such as aniline, ethylenediamine or diethylenetriamine; or a low molecular weight polyol, may be used. Furthermore, a polyester polyol obtained by a dehydration condensation reaction of a low molecular weight polyol with a dicarboxylic acid such as adipic acid or phthalic acid, may be used. Moreover, a polylactone polyol obtained by a ring-opening polymerization of a lactone products such as γ-butyrolactone or ε-caprolactone; and polytetramethylene glycol obtained by a ring-opening polymerization of tetrahydrofuran, may be used. Castor oil or its alkylene oxide adduct; a polydiene polyol which is a polymerized product of a diene compound such as butadiene or isoprene and which has a hydroxy group at the terminal, or its hydrogenated product, may also be used. These may be used singly or in combination of at least two.

As the (meth)acrylate having a hydroxy group, the above-mentioned (meth)acrylate having a hydroxy group may be used.

The urethane(meth)acrylate oligomer (B) may be prepared by reacting the above components. As the proportion of the respective components constituting the urethane(meth)acrylate oligomer (B), for example, 0.4 to 0.8 equivalent amount of the hydroxy group (OH group) of the polyol component and about 0.2 to 0.6 equivalent amount of the (meth) acrylate having a hydroxy group are used to 1 equivalent amount of the isocyanate group (NCO group) of polyisocyanate.

Further, the reaction process of the above components is not particularly limited. In general, it is preferred that polyisocyanate and a polyol component are reacted first and then reacted with a (meth)acrylate having a hydroxy group.

In the urethane formation reaction of the above components, well-known urethane formation catalysts (a metal type catalyst or an amine type catalyst) may be used.

The ethylenic unsaturated compound may include a monofunctional compound, a difunctional compound and a multifunctional compound.

The monofunctional compound may, for example, be N-vinyl pyrrolidone, acryloyl morpholine, N-vinyl acetamide, N-vinyl formamide, N,N′-dimethyl acrylamide, dimethyl aminoethyl(meth)acrylate, diethyl aminoethyl(meth)acrylate, or an alkoxy(poly)alkylene glycol(meth)acrylate such as methoxyethylene glycol(meth)acrylate, methoxypolyethylene glycol(meth)acrylate or butoxypolyethylene glycol(meth)acrylate. Further, nonylphenoxyethyl(meth)acrylate, phenoxyethyl(meth)acrylate, phenoxy polyethylene glycol(meth)acrylate, cumylphenol(poly)alkylene(meth)acrylate, cyclohexyl(meth)acrylate, benzyl(meth)acrylate, dicyclopentenyl(meth)acrylate, and tricyclodecanyl(meth)acrylate may be used.

The difunctional compound may, for example, be ethylene glycol di(meth)acrylate, polyethylene glycol di(meth)acrylate, propylene glycol di(meth)acrylate, polypropylene glycol di(meth)acrylate, 1,4-butanediol di(meth)acrylate, 1,6-hexanediol di(meth)acrylate, neopentyl glycol di(meth)acrylate, pentanediol di(meth)acrylate, or di(meth)acrylate of an alkylene oxide (ethylene oxide, propylene oxide, butylene oxide or the like) adduct of bisphenol A.

Further, the multifunctional compound may, for example, be trimethylolpropane tri(meth)acrylate, trimethylolpropane trioxyethyl(meth)acrylate, pentaerythritol tri(meth)acrylate, dipentaerythritol hexa(meth)acrylate, tris(acryloyloxy)isocyanurate, tri(meth)acrylate of tris(2-hydroxyethyl)isocyanurate, tri(meth)acrylate of tris(hydroxypropyl)isocyanurate, triaryltrimellitic acid or triarylisocyanurate.

These ethylenic unsaturated compounds may be used singly or in combination of at least two. When an ethylenic unsaturated compound is used, selection should be made taking into consideration odor and skin stimulative property of the compound.

The amounts of the urethane(meth)acrylate oligomer (B) and ethylenic unsaturated compound are selected depending on the type of the urethane(meth)acrylate oligomer and ethylenic unsaturated compound, the desired viscosity of the resin composition, etc. For example, the amount maybe selected from a range of at most 50 parts by weight, preferably at most 20 parts by weight, more preferably at most 5 parts by weight, to 100 parts by weight of the urethane (meth) acrylate oligomer of the formula (I).

In the present invention, a photopolymerization initiator which absorbs light within a wavelength range of 400 to 700 nm is used. As such a compound, a bisacylphosphine oxide type photopolymerization initiator represented by the following formula (III) may be used:

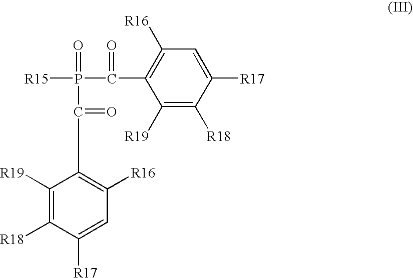

wherein R15 denotes a straight chain or branched chain C₁₋₁₂ alkyl group, a cycloalkyl group, an aryl group which may be substituted by a straight chain or branched chain C₁₋₁₂ alkyl group or a halogen atom; each of R16 and R17, which may be the same or different, denotes a hydrogen atom, a straight chain or branched chain C₁₋₁₂ alkyl group, or a straight chain or branched chain C₁₋₁₂ alkoxy group; and each of R18 and R19, which may be the same or different, denotes a hydrogen atom, or a straight chain or branched chain C₁₋₁₂ alkyl group.

As the straight chain or branched chain C₁₋₁₂ alkyl group in the above formula (III), methyl, ethyl, propyl, isopropyl, butyl, s-butyl, t-butyl, pentyl, isopentyl, 2,4,4-trimethylpentyl, hexyl, isohexyl, 2,4,4-trimethylhexyl, octyl, decyl and dodecyl groups may, for example, be used.

As R15, preferred is a branched chain C₆₋₁₂ alkyl group, and particularly preferred is a branched chain C₆₋₁₀ alkyl group.

As the cycloalkyl group, a C₃₋₁₀ cycloalkyl group such as a cyclopentyl, cyclohexyl or cyclooctyl group may be used, and a C₅₋₁₀ cycloalkyl group is preferably used.

The aryl group may include phenyl and naphthyl groups, and the aryl group may be substituted by a straight chain or branched chain C₁₋₁₂ alkyl group or a halogen atom. The C₁₋₁₂ alkyl group includes alkyl groups as previously mentioned, and is generally preferably a straight chain or branched chain C₁₋₄ alkyl group (methyl, ethyl, propyl, isopropyl, butyl, t-butyl or the like).

The halogen atom includes fluorine, chlorine, bromine and iodine atoms.

Further, the straight chain or branched chain C₁₋₁₂ alkoxy group may, for example, be methoxy, ethoxy, propoxy, isopropoxy, butoxy, isobutoxy, 's-butoxy, t-butoxy, pentyloxy, hexyloxy or octyloxy group. Preferred alkoxy group is a straight chain or branched chain C₁₋₄ alkoxy group. Further, the preferred combination of R15 to R19 is as follows:

R15: a C₁₋₁₂ alkyl group (particularly a branched chain C₆₋₁₂ alkyl group), or an aryl group (particularly a phenyl group), R16 and R17: a C₁₋₄ alkyl group (particularly a C₁₋₂ alkyl group) or a C₁₋₄ alkoxy group (particularly a C₁₋₂ alkoxy group), and R18 and R19: a hydrogen atom or a C₁₋₄ alkyl group (particularly a methyl group).

The bisacylphosphine oxide type photopolymerization initiator may include a bis(2,6-di C₁₋₂ alkoxybenzoyl)-branched chain C₆₋₁₂ alkylphosphine oxide such as bis(2,6-dimethoxybenzoyl)-2,4,4-trimethyl pentyl phosphine oxide. Further, a bis(2,4,6-tri C₁₋₂ alkylbenzoyl) C₁₋₆ alkylphosphine oxide such as bis(2,4,6-trimethylbenzoyl)methylphosphine oxide, bis(2,4,6-trimethylbenzoyl)ethylphosphine oxide or bis(2,4, 6-trimethylbenzoyl)-n-butylphosphine oxide, may also be included. Moreover, bis(2,4,6-tri C₁₋₂ alkylbenzoyl)arylphosphine oxide such as bis(2,4,6-trimethylbenzoyl)phenylphosphine oxide may be used. These bisacylphosphine oxide type photopolymerization initiators may be used singly or in combination of at least two. Preferred is bis(2,4,6-trimethylbenzoyl)phenylphosphine oxide.

Further, as the photopolymerization initiator which absorbs light within a wavelength range of 400 to 700 nm, a titanocene type photopolymerization initiator represented by the following formula (IV), campherquinone, etc. may be used:

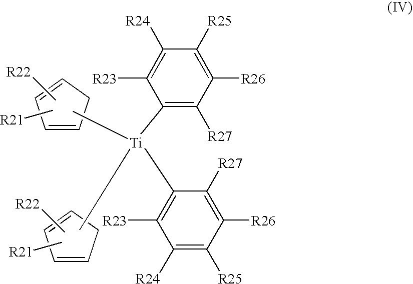

in which each of R21 and R22 independently denotes a hydrogen atom or a methyl group; R23 denotes a fluorine atom, —CF₃ or —CF₂CH₃; and each of R24, R25, R26 and R27 independently denotes a hydrogen atom, a fluorine atom, —CF₃, —CF₂CH₃, a C₁-C₁₂ alkyl group or alkoxy group, a 6-membered carbocyclic aromatic group, or a 5- or 6-membered heterocyclic aromatic group.

The titanocene type photopolymerization initiator may, for example, be bis(cyclopentadienyl)-bisphenyltitanium, bis(cyclopentadienyl)-bis(2,3,4,5,6-pentafluorophenyl)titanium, bis(cyclopentadienyl)-bis(2,3,5,6-tetrafluorophenyl)titanium, bis(cyclopentadienyl)-bis(2,4,6-trifluorophenyl)titanium, bis(cyclopentadienyl)-bis(2,6-difluorophenyl)titanium, bis(cyclopentadienyl)-bis(2,4-difluorophenyl)titanium, bis(methylcyclopentadienyl)-bis(2,3,4,5,6-pentafluorophenyl)titanium, bis(methylcyclopentadienyl)-bis(2,3,5,6-tetrafluorophenyl)titanium, bis(methylcyclopentadienyl)-bis(2,6-difluorophenyl)titanium, bis(cyclopentadienyl)-bis(2,6-difluoro-3-(pyrrol-1-yl)phenyl)titanium, bis(cyclopentadienyl)-bis(2,4,6-trifluoro-3-(pyrrol-1-yl)phenyl)titanium, and bis(cyclopentadienyl)-bis(2,4,6-trifluoro-3-(2-5-dimethylpyrrol-1-yl)phenyl)titanium. These titanocene type photopolymerization initiators may be used singly or in combination of at least two. A preferred titanocene type photopolymerization initiator is bis(cyclopentadienyl)-bis(2,6-difluoro-3-(pyrrol-1-yl)phenyl)titanium.

The above-mentioned bisacylphosphine oxide type photopolymerization initiator, titanocene type photopolymerization initiator and campherquinone may be used in combination appropriately with other photopolymerization initiators (for example, an acetophenone type or propiophenone type photopolymerization initiator, a benzyl type, benzoin type or benzophenone type photopolymerization initiator, or a thioxanthone type photopolymerization initiator).

The acetophenone type or propiophenone type photopolymerization initiator may, for example, be an acetophenone such as 2,2-dimethoxy-2-phenyl acetophenone, acetophenone diethylketal or diethoxy acetophenone, or its derivative; or an oligomer of 2-hydroxy-2-methyl-1-phenylpropan-1-one, 2-benzyl-2-dimethylamino-1-(4-morpholinophenyl)-butanone, 2-methyl-2-morpholino(4-thiomethylphenyl)propan-1-one or 2-hydroxy-2-methyl-1-[4-(1-methylvinyl)phenyl]propanone.

As the benzyl type photopolymerization initiator, benzyl and benzyl dimethylketal may be used.

Further, as the benzoin type photopolymerization initiator, benzoin, benzoin methyl ether, benzoin ethyl ether, benzoin isopropyl ether, benzoin isobutyl ether or the like may be used.

The benzophenone type photopolymerization initiator may, for example, be benzophenone, methyl o-benzoylbenzoate, 4-phenyl benzophenone, 3,3′-dimethyl-4-methoxy benzophenone, 4,4′-methoxy benzophenone, 4-benzoyl-4′-methyldiphenyl sulfide, 2,4,6-trimethyl benzophenone and (4-benzoylbenzyl)trimethylammonium chloride.

Further, the thioxanthone type photopolymerization initiator may, for example, be 2- or 4-isopropyl thioxanthone, 2,4-diethyl thioxanthone and 2,4-dichloro thioxanthone.

Furthermore, other photopolymerization initiators may, for example, be 1-hydroxycyclohexyl phenyl ketone, methylphenyl glyoxy ester and 3,6-bis(2-morpholino isobutyl)-9-butyl carbazole.

The amount of the photopolymerization initiator is about 0.01 to 10 parts by weight, preferably 0.05 to 2 parts by weight, to 100 parts by weight of the urethane (meth)acrylate oligomer or 100 parts by weight of the total amount of the urethane(meth)acrylate oligomer, urethane(meth)acrylate oligomer (B) and ethylenic unsaturated compound.

In the photocurable resin of the present invention, a photosensitizer may further be incorporated as the case desires.

Such a photosensitizer may be a coumarin derivative such as 7-diethylamino-3-(2-benzothiazolyl)coumarin, 7-diethylamino-3-(2-benzimidazolyl)coumarin, 7-diethylamino-3-benzoylcoumarin, 7-diethylamino-3-thiazolylcoumarin, 7-diethylamino-3,3′-carbonylbiscoumarin, 7-diethylamino-3-(4-tert-butyldioxy carbonyl methoxybenzoyl)coumarin or 5,7-dimethoxy-3-(4-tert-butyldioxy carbonyl methoxybenzoyl)coumarin. Further, a xanthene type dye such as eosine, ethyl eosine, erythrosine, fluorescein or rose Bengal; a triarylmethane dye; a methine dye; an azo dye; a cyanine dye; a thiopyrylium dye; a diphenyliodenium dye; and a pyromethene complex such as 2,6-diethyl-1,3,5,7, 8-pentamethyl pyromethene-BF₂ complex or 1,3,5,7,8-pentamethyl pyromethene-BF₂ complex, may be used. Furthermore, a ketothiazoline compound such as 1-(1-methylnaphtho[1,2-d]thiazol-2(1H)-ylidene-4-(2,3,6,7) tetrahydro-1H,5H-benzo[ij]quinolizin-9-yl)-3-buten-2-one, or 1-(3-methylbenzothiazol-2(3H)-ylidene-4-(p-dimethylamino phenyl)-3-buten-2-one; a styryl or phenylbutadienyl heterocyclic compound such as 2-(p-dimethylamino styryl)-naphtho[1,2-d]thiazole or 2-[4-(p-dimethyamino phenyl)-1,3-butadienyl]-naphtho[1,2-d]thiazole; and a triazine compound such as 2,4-diphenyl-6-(p-dimethylaminostyryl)-1,3,5-triazine, 2,4-diphenyl-6-(([2,3,6,7]tetrahydro-1H,5H-benzo[ij]quinolizin-9-yl)-1-ethen-2-yl)-1,3,5-triazone, may be mentioned. Further, an aminophenyl unsaturated ketone compound such as 9-phenanthryl-(([2,3,6,7]tetrahydro-1H,5H-benzo[ij]quinolizin-9-yl)-1-ethen-2-yl)ketone or 2,5-bis(p-dimethylaminocinnamylidene)cyclopentanone; a porphyrin such as 5,10,15,20-tetraphenylporphyrin or hematoporphyrin may, for example, be used.

Various types of photopolymerization promoters may be added to the photocurable resin composition of the present invention, if the case requires, in order to accelerate the photopolymerization reaction with a photopolymerization initiator. Such photopolymerization promoters may, for example, include a dialkylaminobenzoic acid or its derivative such as 4-dimethylaminobenzoic acid or 4-dimethylaminobenzoic acid ester, an arylphosphine such as triphenylphosphine, and a phosphine compound such as a trialkylphosphine. These photopolymerization promoters may be used singly or in combination of at least two.

As the amount of the photopolymerization promoter, it may be selected from the range of about 0.01 to 10 parts by weight to 100 parts by weight of the urethane type (meth)acrylic acid derivative oligomer or 100 parts by weight of the total amount of the urethane type (meth)acrylic acid derivative oligomer, urethane(meth)acrylate oligomer (B) and ethylenic unsaturated compound.

To the photocurable resin of the present invention, various types of additives may be added depending on the purpose or necessity of the fixture. Such additives may be a polymerization inhibitor (hydroquinone, methoxyhydroquinone or the like), an antioxidant, a tacky-free agent (silicone oil or the like), a thixotropy-imparting agent (castor oil fatty acid amide, dibenzylidene sorbitol or the like), a dye, a pigment, a silane coupling agent, a surfactant, a colorant, organic or inorganic fine particles, etc.

The base material of the present invention is used to retain the photocurable resin so as to form a fixture for orthopedic surgery. As such a base material, woven fabric, knit, nonwoven fabric, etc. using various types of fibers may be used. As the fibers, natural fibers (cellulose fibers, protein fibers, etc.), and chemical fibers (regenerated fibers, semi-synthetic fibers, synthetic fibers, inorganic fibers, etc.), may be used. For example, cotton, wool, rayon, polyamide fibers, polyester fibers, acryl fibers, polyolefin fibers, glass fibers, carbon fibers and other fibers may be used. In general, as the base material, ones having a high modulus of elasticity in tension, for example, about 800 Mpa or higher, is suitable.

As the base material, knit obtained by Raschel knitting using aggregate (yarn) of glass fibers or polyester fibers is particularly preferably used.

As the light source for curing the photocurable fixture for orthopedic surgery in accordance with the present invention, a light source that produces light of 400 to 700 nm as the absorption wavelength of the photopolymerization initiator may be used. As the light source, a light source that produces visible light such as a fluorescent lamp used in an ordinary home, a halogen lamp, a krypton lamp or LED may be used. Further, as the case requires, a light source producing a wavelength of 400 nm or lower, such as a black lamp or a high-pressure mercury-vapor lamp, may be used.

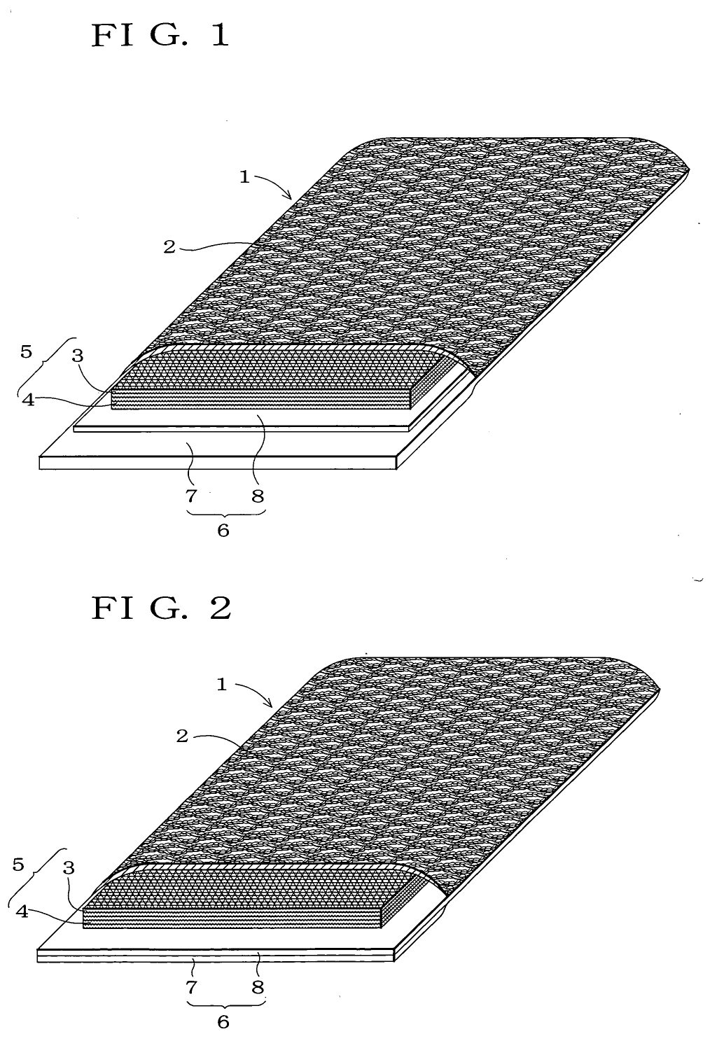

A splint material 1 as one embodiment of the fixture for orthopedic surgery of the present invention will be explained with reference to FIG. 1. The splint material 1 has a cover material 2 disposed as the outermost layer (i.e., the layer to be positioned on the side opposite to an affected part), and inside the outermost layer is disposed a support material 5 comprising a base material 3 and a photocurable resin 4 retained therein. Further, at the inner side of the support material 5 (i.e., the side facing the affected part) is disposed a buffer material 6. In this embodiment, the buffer material 6 is a two-layer structure comprised of a lower, thicker layer 7 and an upper, thinner layer 8. The support material 5 is wrapped and enclosed by the cover material 2 on the outer or upper side and by the buffer material 6 on the inner or lower side. If necessary or desirable, both the buffer material 6 and the support material 5 can be wrapped entirely with the cover material 2.

In FIG. 1, the photocurable resin 4 of the support material 5 is not exposed through the cover material 2, and even if the fixture is handled with bare hands over the cover material 2, the person will not touch or otherwise come in direct contact with the photocurable resin 4. Further, when a bandage is wound over the cover material 2 of the splint material 1 to fix it to the affected part, uncured resin will not adhere to the bandage.

As such a cover material 2, one capable of transmitting light and ventilating air and having an appropriate elasticity may preferably be used. Further, preferably, the cover material 2 does not allow the photocurable resin 4 to penetrate and reach the surface, and the cover material 2 is unreactive with the photocurable resin 4. For example, the open area ratio of the cover material is about 10 to 60%, preferably about 30 to 50%, and its thickness is about 0.05 to 8 mm, preferably about 1 to 4 mm. As the cover material 2, knit, woven fabric, nonwoven fabric, sheet, etc. using synthetic fibers of a polyfluoroethylene type, a polyester type, a polyolefin type, a polyvinyl chloride type, etc.; semi-synthetic fibers of rayon, etc.; natural fibers such as cotton, etc., may be used.

The open area ratio is a proportion of area occupied by voids within a certain range, and can be mechanically determined by taking an enlarged picture of the base material and carrying out image recognition.

With the cover material 2, it is preferred to conduct an oil repellent treatment with a fluorine system treatment agent so as to prevent attachment and penetration of the uncured photocurable resin 4. The fluorine system treatment agent may, for example, include a copolymer comprising as the main component an acrylic acid derivative (perfluoro monomer) prepared by an esterification of a compound having a perfluoroalkyl group and a hydroxy group with acrylic acid, methacrylic acid or the like. As the copolymer component, a monomer such as an alkyl(meth)acrylate or vinyl chloride, a crosslinkable monomer such as 2-hydroxyethyl(meth)acrylate or N-methylacrylamide, may be used.

Further, if fibers of polyfluoroethylene type, etc. are used for the cover material 2, oil repellency may sometimes be obtained without the above special oil repellent treatment.

As the cover material 2, a light-transmissive film may be used. As the material thereof, a polyfluoroethylene type, a polyester type, a polyolefin type, a polyvinyl chloride type, etc. may be used. If small pores are formed in these films, air permeability can be obtained, such being preferable.

Further, these films may be used in combination with knit, woven fabric, nonwoven fabric, sheet, etc. to form a cover sheet.

The buffer material 6 preferably has a buffering property such that contact with the affected part is soft, and the buffer material prevents transmittance of reaction heat of the photocurable resin 4 at the time of curing towards the affected part. Further, preferably, it hardly allows the uncured photocurable resin 4 to penetrate to the affected part, and has an appropriate air permeability. Moreover, as the buffer material 6, preferred is one that is unreactive with the photocurable resin 4 of the support material 2, flexible, and deformable such that it follows the shape of the affected part, and has good moldability.

For example, a thick nonwoven fabric using synthetic fibers such as a polyester type, a polyolefin type or a polyvinyl chloride type, semi-synthetic fibers of rayon, or natural fibers such as cotton; or a three-dimensional knit or woven fabric, may be used. Further, a homogeneous foam of a single or composite body of, for example, a urethane type, a polyolefin type, or an ethylene/vinyl acetate copolymer (EVA); a foam having a skin layer; a laminate of the above respective materials; a combined structure of a nonwoven fabric or a three-dimensional knit/woven fabric with a foam, etc., may be used.

The thickness of the buffer material 6 is desirably as thin as possible so far as it has the above properties and functions, usually about 1 to 17 mm, preferably about 2 to 15 mm. If it is thinner than 1 mm, the above functions are likely not attainable, and if it exceeds 17 mm, its moldability tends to be poor.

The buffer material 6 may, as illustrated, be a multi-layer structure. In this instance, the lower layer 7 (affected part side) is desirably one capable of making soft contact with the affected part and has air permeability, less skin-irritant properties and antibacterial properties. If one having air permeability is used for the lower layer 7, a material having no or less air permeability may be used for the upper layer 8 (non-affected part side). In the fixture shown in FIG. 1, a nonwoven fabric of polyester fibers is used for the lower layer 7 of the buffer layer 6 and a foam sheet of an ethylene/vinyl acetate copolymer is used for the upper layer 8 thereof.

Depending on its application, a splint material formed in a fixed shape or a roll shape may be stored in a non-light-transmissive packaging material. With a large sized one of, for example, a roll shape, a desired amount is taken out from the packaging material and cut off, and the rest is returned to the packaging material, and it can be used in the same manner the next time, whereby long time storage is possible.

When the splint material 1 is used, it is taken out from the non-light-transmissive packaging material, etc., and the buffer material side 6 of the splint material 1 is put directly on the affected part, and the splint material is shaped and deformed by hand from the outside. Then the shaped splint material is fixed by wrapping it with a bandage, etc. and molding is conducted by irradiation with visible light. Irradiation of visible light initiates the curing reaction of the photocurable resin 4 of the support material 5. As the curing proceeds gradually, the entire part is cured and the splint is finished. The splint fixes the affected part in proper position for healing and can be detached optionally if required.

Another embodiment of the splint material 1 is shown in FIG. 2 and is formed in the same manner as the one shown in FIG. 1 except that the lower layer 7 and upper layer 8 of the buffer layer 6 are of the same size and thickness. The splint material of the second embodiment may be used in the same manner as the one in FIG. 1.

A cast material as another embodiment of a fixture for orthopedic surgery according to the present invention will be explained hereinbelow. In preparation of the cast material, a photocurable resin is applied on a base material made of the above-mentioned material formed in a belt shape, and it is wound in a roll shape, and stored in a non-light-transmissive packaging material.

In use, it is taken out from the non-light-transmissive packaging material by hand wearing protective gloves such as rubber gloves. A protective material for protecting the skin is wound beforehand around the affected part, and while rewinding the photocurable fixture of the roll shape, it is wound on the affected part, and then it is cured by irradiation with light.

After the fixture is wound on the affected part, before curing, if the photocurable fixture is covered with a thin nonwoven fabric, etc., it becomes possible to form the fixture by bare hands so that it fits to the affected part. Further, since the nonwoven fabric covers the surface of the fixture even after the curing, it is possible to obtain a cast of a soft touch texture. Moreover, a separator may be disposed between a base material and another base material so that the woven fabric can be wound smoothly.

As a further embodiment of a fixture for orthopedic surgery according to the present invention, the fixture may be used as a stay material for various types of braces to be attached to the body. Namely, the fixture of the present invention may be used as a fixing material, a supporting material, a protecting material, etc. to impart strength to various types of braces such as an ankle brace, a knee joint brace, a low-back pain belt, or an upper limb orthosis. For example, in the above braces, a stay material is disposed for fixing, supporting or protecting, inside a flexible main body.

Such braces can likewise be kept in a non-light-transmissive packaging material. In use, the brace is taken out from the packaging material and applied to the site for use, and irradiation with light is conducted from the outside to cure the supporting material.

Further, the stay material may be covered with a cover material and stored in a non-light-transmissive packaging material. When the stay material is used, it is taken out from the packaging material and irradiated with light for curing, and then inserted into, for example, a pocket formed in the brace. The brace combined with the stay material is applied by putting it to the affected part.

In this instance, the stay material may be put in and taken out from the brace. Depending on the symptom, demands, etc. of patients, a stay material having an appropriate size, strength, etc. is combined with a brace, to further facilitate the preparation of a brace suitable for the symptom.

### EXAMPLES

The following were prepared as the materials and equipment for examples and comparative examples.

1. Materials
(1) Epoxy ester M-600A (phenyl glycidyl ether acrylate) (PGEA; manufactured by Kyoeisha Chemical Co., Ltd)
(2) 3-Phenoxy-2-hydroxy methacrylate (phenyl glycidyl ether methacrylate) (PGEMA; manufactured by Hampford Research Inc.)
(3) Light ester HOA (2-hydroxyethyl acrylate) (HEA; manufactured by Kyoeisha Chemical Co., Ltd)
(4) Light ester HO (2-hydroxyethyl methacrylate) (HEMA; manufactured by Kyoeisha Chemical Co., Ltd)
(5) Light ester HOP-A (2-hydroxypropyl acrylate) (HPA; manufactured by Kyoeisha Chemical Co., Ltd)
(6) N-(2-hydroxyethyl)acrylamide (HEAA; manufactured by Kohjin Co., Ltd.)
(7) 2-isocyanatoethyl-2,6-diisocyanatocaproate (LTI; manufactured by Kyowa Hakko Kogyo Co., Ltd.)
(8) 1,6,11-Undecanetriisocyanate (UTI)
(9) Dibutyltin dilaurate (manufactured by Wako Pure Chemical Industries Ltd.)
(10) p-Methoxyphenol (MEHQ; manufactured by Wako Pure Chemical Industries Ltd.)
(11) Teslac 2325 (urethaneacrylate oligomer of PGEA/HEMA (mixture of 1/1 in mole) with hexamethylene diisocyanate; manufactured by Hitachi Kasei Polymer Co., Inc.)
(12) Irgacure 784 (bis(cyclopentadienyl)-bis(2,6-difluoro-3-(pyrrol-1-yl)phenyl)titanium) (Irgacure 784; manufactured by Ciba Japan Co.)
(13) Irgacure 819 (bis(2,4,6-trimethylbenzoyl)phenylphosphine oxide) (Irgacure 819; manufactured by Ciba Japan Co.)
(14) Epoxy ester 3000A (Bisphenol A diglycidyl ether acrylic acid adduct) (manufactured by Kyoeisha Chemical Co., Ltd)
(15) Light ester 3EG (Triethylene glycol dimethacrylate) (manufactured by Kyoeisha Chemical Co., Ltd)
(16) Epoxy ester 3002M (Epolite 3002 methacrylic acid adduct) (manufactured by Kyoeisha Chemical Co., Ltd)
(17) NK Oligo UA-5201 (Polyether polyol type non-yellowing urethane) (manufactured by Shin-Nakamura Chemical Co., Ltd, (molecular weight: about 1,000)
(18) NK Oligo UA-160TM (Polytetramethylene glycol type non-yellowing urethane acrylate, molecular weight: about 1,600) (Shin-Nakamura Chemical Co.,Ltd)

2. Light Source

Fluorescent lamp: 27W, U-line flat T FML27EX-D (three-band daylight) manufactured by Toshiba Corporation

[Process For Producing a Photocurable Resin]

In preparation of a photocurable resin, at first, an oligomer was produced.

### Preparation Example 1 of Oligomer

429.7 parts of PGEA (all parts by weight) 224.5 parts of HEA and 0.2 part of MEHQ as indicated in Table 1, were placed in a flask equipped with stirring vanes and a thermometer, and heated to 60° C. with stirring, to dissolve MEHQ. 0.1 part of dibutyltin dilaurate was added thereto, and subsequently 344.5 parts of LTI was added thereto, and reaction was carried out at 75 to 85° C. for 5 hours with stirring to obtain a urethane type (meth)acrylic acid derivative oligomer.

### Preparation Examples 2 to 6 of Oligomer

The acrylic acid derivative having an active hydrogen group and the polyisocyanate indicated in Table 1 were reacted in the same manner as in the above Preparation Example 1, to obtain urethane type (meth)acrylic acid derivative oligomers of Preparation Examples 2 to 6.

### Examples 1 to 8

In Examples 1 to 7, each of the oligomers for Preparation Examples 1 to 6 indicated in Table 2 was put in a flask equipped with stirring vanes and a thermometer, and under shading, heating was carried out with stirring and the temperature was raised to 60° C. Then, Irgacure 784 or Irgacure 819 as indicated in Table 2 was added, and dissolved to produce the photocurable resins of Examples 1 to 7.

In Example 8, the oligomer of Preparation Example 1 and another oligomer (Teslac 2325) were blended as indicated in Table 2, and then a photocurable resin of Example 8 was obtained in accordance with Examples 1 to 7.

### Comparative Examples 1 to 5

Materials indicated in Table 3 were added, dissolved and reacted to produce the photocurable resins of Comparative Examples 1 to 5.

[Preparation of a Photocurable Fixture]

In all of the Examples and Comparative Examples, a photocurable resin was applied to a base material at a rate of 270±30 g/m² by a roll coater system.

The base material having the photocurable resin applied was cut in a predetermined length, and overlaid in six layers, and this was put on a buffer material, further a cover material as indicated below was put thereon and fused by heating with the buffer material, and it was enclosed in a non-light-transmissive bag to prepare a splint material.

As the base material, a tape-shaped base material obtained by Raschel knitting of glass fibers, with a warp of 14 lines/2.54 cm (1 inch), a weft of 11 lines/2.54 cm, a weight (METSUKE) of 270 g/m², a thickness of 1.02 mm and a width of 100 mm, was used.

As a buffer material, a needle-punched two-layer type nonwoven fabric with a thickness of 3.2 mm and a weight (METSUKE) of 300 g/cm², which is a nonwoven fabric having a two-layer structure of which one layer is a polyester nonwoven fabric (inner side=core material side) and the other is a mixed nonwoven fabric of rayon and polyester (outer side=skin side), was used.

The surface of the core material which was opposite side of the buffer material, was covered with a polypropylene perforated film (thickness: 20 μm, pore diameter: 0.5 mm, pitch of pores is 1.5 mm in both lengthwise and widthwise directions), and further covered with a thermal bonded nonwoven fabric (thickness: 200 μm, weight (METSUKE): 25 g/m²) using a polypropylene/polyethylene conjugated fibers, and then heat sealed.

[[Tests]]

The following tests were conducted for evaluation of the photocurable fixtures and the physical properties of the photocurable resins in the above Examples and Comparative Examples.

As the light source for curing, the above-mentioned fluorescent lamp of 27 W was used.

[Odor]

The odor after the photocurable resin was applied on the base material was evaluated by sensory test.

[Working Period]

In a measuring room adjusted to a room temperature 23° C. and a humidity 65% RH, a photocurable fixture was taken out from a non-light-transmissive bag and placed 1.5 m below two lighted fluorescent lamps of 40 W (illuminance: about 650 lux) which were more intense than the above light source for curing. The degrees of curing were observed every 10 seconds to determine whether or not formation could be made.

[Bending Strength]

In a measuring room adjusted to a room temperature 23° C. and a humidity 65% RH, a splint material as a photocurable fixture was taken out from a non-light-transmissive bag, and cut in a length of about 10 cm, and irradiated with the above-mentioned fluorescent lamp of 27 W for one minute while the illuminance on the surface of the curing test piece was adjusted to 6,000 lux. The bending strength after 10 minutes passed from initiation of the irradiation with light was measured. The illuminance was measured by an LM-332 manufactured by AS ONE Corporation.

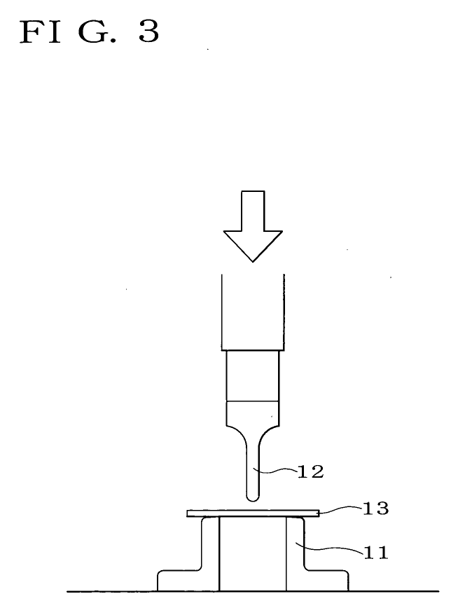

In the measurement, a bending test was carried out in accordance with JIS K7171 with Autograph AG-D (computer measured and controlled precision universal tester, manufactured by Shimadzu Corporation) using a 3-point bending test jig. The 3-point bending test jig had a distance of 50 mm between supporting points and was provided with a supporting portion 11 with a length of 120 mm as shown in FIG. 3. A specimen 13 was put on the supporting portion 11, and a load was applied with an indentor 12 having a length of 110 mm. The testing speed was 100 mm/min.

[[Results of Tests]]

The measurement results concerning the physical properties and evaluations of respective Examples and Comparative Examples are indicated in Tables 2 and 3.

[Odor]

With the photocurable resins in Comparative Examples 1 to 3, an unpleasant acid smell was recognized, and this was particularly strong in Comparative Example 2.

In the Examples and other Comparative Examples, such odor was not recognized, and these were acceptable from the standpoint of odor.

[Working Period]

In each Example, the working period was 2 minutes. In the Comparative Examples, it was substantially the same level as in the Examples.

[Bending Strength]

In the conventionally used water-curable splint material, if the strength (initial strength) at the point of about 10 minutes later does not reach at least about 150 N, such material is not practically used. Further, as the strength after 24 hours, it is considered that at least 500 N is necessary for fixing the affected parts.

In the case of a photocurable splint material, the curing is almost completed during the irradiation with light, and thereafter, increase in strength can hardly be seen with the lapse of time. In respective Examples in Table 2, since at least 700 N can be obtained after 10 minutes, these fixtures satisfy the required strength after 24 hours of the water-curable splint material, and thus it is found that sufficient curing properties are possessed.

On the contrary, in the Comparative Examples in Table 3, the strength is at most 135 N, and the strengths are all less than the required strength, such being insufficient in strength. Further, as mentioned above, an unpleasant acid odor is recognized in Comparative Examples 1 to 3 and these cannot be suitably applied to the use of the present invention for this reason as well.

[Total Evaluation]

As mentioned above, with the photocurable resins in the Examples, no substantial odor is recognized and, although it cures relatively fast as a fixture, sufficient working period can be obtained. Further, the heat generation temperature is 40° C. or lower in all cases at the time of using the photocurable fixture, and no inconvenience is seen in use. And, in the bending strength of the splint material, sufficient strength can be obtained, and these can be suitably used as the fixture.

On the other hand, with the ones in the Comparative Examples, the bending strength is low, and it is impossible to obtain sufficient strength. Further, some of the photocurable resins have odor and cannot be suitably used.

It will be appreciated by those ordinarily skilled in the art that obvious variations and changes can be made to the examples and embodiments described in the foregoing description without departing from the broad inventive concept thereof. It is understood, therefore, that this disclosure is not limited to the particular examples and embodiments disclosed, but is intended to cover all obvious modifications thereof which are within the scope and the spirit of the disclosure as defined by the appended claims.

TABLE 1

| | | P.E. | P.E. | P.E. | P.E. | P.E. | |
|---|---|---|---|---|---|---|---|
| | | 1 | 2 | 3 | 4 | 5 | P.E. 6 |
| Acrylic | PGEA | 429.7 | 418.3 | 418.3 | | 423.2 | 430.5 |
| acid derivative | PGEMA | | | | 444.7 | | |
| with | HEA | 224.5 | | | 218.6 | 220.9 | |
| active | HEMA | | 245.0 | | | | |
| hydrogen | HPA | | | 245.0 | | | |
| group | HEAA | | | | | | 223.1 |
| Polyiso- | LTI | 344.5 | 335.4 | 335.4 | 335.4 | | 345.2 |
| cyanate | UTI | | | | | 354.6 | |
| Dibutyltin | | 0.1 | 0.1 | 0.1 | 0.1 | 0.1 | |
| dilaurate | | | | | | | |
| MEHQ | | 0.2 | 0.2 | 0.2 | 0.2 | 0.2 | 0.2 |
| Subtotal | | 999.0 | 999.0 | 999.0 | 999.0 | 999.0 | 999.0 |

Note:
P.E. = Preparation Example

TABLE 2

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Oli. of P.E. 1 | 999.0 | | | | | | 990.0 | 499.5 |
| Oli. of P.E. 2 | | 999.0 | | | | | | |
| Oli. of P.E. 3 | | | 999.0 | | | | | |
| Oli. of P.E. 4 | | | | 999.0 | | | | |
| Oli. of P.E. 5 | | | | | 999.0 | | | |
| Oli. of P.E. 6 | | | | | | 998.0 | | |
| Subtotal | 999.0 | 999.0 | 999.0 | 999.0 | 999.0 | 998.0 | 990.0 | 499.5 |
| Teslac 2325 | | | | | | | | 499.5 |
| Irgacure 784 | 1.0 | 1.0 | 1.0 | 1.0 | 1.0 | 2.0 | | 1.0 |
| Irgacure 819 | | | | | | | 10.0 | |
| Total | 1000.0 | 1000.0 | 1000.0 | 1000.0 | 1000.0 | 1000.0 | 1000.0 | 1000.0 |
| Odor | *1 | *1 | *1 | *1 | *1 | *1 | *1 | *1 |
| Working | 2 | 2 | 2 | 2 | 2 | 2 | 2 | 2 |
| period (min.) | | | | | | | | |
| Illuminance | 6,000 | 6,000 | 6,000 | 6,000 | 6,000 | 6,000 | 6,000 | 6,000 |
| (lux) | | | | | | | | |
| Irradiation | 1 | 1 | 1 | 1 | 1 | 1 | 1 | 1 |
| time (min.) | | | | | | | | |
| Bending | 800 | 700 | 750 | 750 | 810 | 760 | 790 | 780 |
| strength (N) | | | | | | | | |
| (10 min.) | | | | | | | | |

Note:
Oli. = oligomer,
P.E. = Preparation Example,
*1 = substantially no odor

TABLE 3

| | Com. | Com. | Com. | Com. | Com. |
|---|---|---|---|---|---|
| | Ex. 1 | Ex. 2 | Ex. 3 | Ex. 4 | Ex. 5 |
| Epoxy ester 3000A | 999 | | | | |
| Light ester 3EG | | 999 | | | |
| Epoxy ester 3002M | | | 999 | | |
| NE Oligo UA-5201 | | | | 999 | |
| NE Oligo UA-160TM | | | | | 999 |
| Irgacure 784 | 1 | 1 | 1 | 1 | 1 |
| Total | 1,000 | 1,000 | 1,000 | 1,000 | 1,000 |
| Viscosity (25° C.) | 100,000 | | | 43,000 | 24,900/ |
| (mPa · s) | | | | | 40° C. |
| Odor | *2 | *3 | *2 | *1 | *1 |
| Working period (min.) | 2 | 2 | 2 | 2 | 2 |
| Illuminance (lux) | 6,000 | 6,000 | 6,000 | 6,000 | 6,000 |
| Irradiation time (min.) | 1 | 1 | 1 | 1 | 1 |
| Bending strength | 88 | 135 | 98 | 135 | 79 |
| (N) (10 min.) | | | | | |

Note:
*1 = substantially no odor,
*2 = acidic odor,
*3 = strong acidic odor

We claim:

1. A photocurable fixture for orthopedic surgery, comprising: a base material; and a photocurable resin retained in the base material, the photocurable resin containing a urethane type (meth)acrylic acid derivative oligomer obtainable by a polyisocyanate having at least three isocyanate groups and a (meth)acrylic acid derivative having an active hydrogen group, and a photopolymerization initiator which absorbs light within a range of 400 to 700 nm.

2. A photocurable fixture for orthopedic surgery according to claim 1; wherein the active hydrogen group of the (meth)acrylic acid derivative is either one of a hydroxy group, an amino group or a mercapto group, and the (meth)acrylic acid derivative is a (meth)acrylate or a (meth)acrylamide.

3. A photocurable fixture for orthopedic surgery according to claim 2; wherein the (meth)acrylic acid derivative is a (meth)acrylate having a hydroxy group represented by the following formula (II), 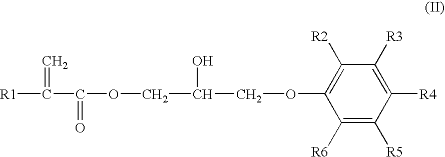
wherein each of R1 to R6 denotes a hydrogen atom or a methyl group.

4. A photocurable fixture for orthopedic surgery according to claim 1; wherein the photopolymerization initiator is a bisacylphosphine oxide type photopolymerization initiator represented by the following formula (III): 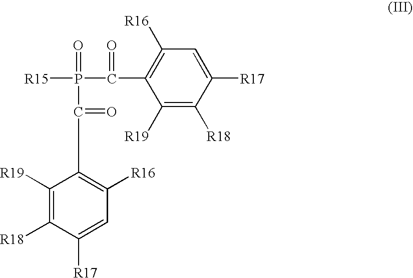
wherein R15 denotes a straight chain or branched chain C₁₋₁₂ alkyl group, a cycloalkyl group, an aryl group which may be substituted by a straight chain or branched chain C₁₋₁₂ alkyl group or a halogen atom; each of R16 and R17, which may be the same or different, denotes a hydrogen atom, a straight chain or branched chain C₁₋₁₂ alkyl group, or a straight chain or branched chain C₁₋₁₂ alkoxy group; and each of R18 and R19, which may be the same or different, denotes a hydrogen atom, or a straight chain or branched chain C₁₋₁₂ alkyl group.

5. A photocurable fixture for orthopedic surgery according to claim 4; wherein the photopolymerization initiator is bis(2,4,6-trimethylbenzoyl)phenyl phosphine oxide.

6. A photocurable fixture for orthopedic surgery according to claim 1; wherein the photopolymerization initiator is a titanocene type photopolymerization initiator represented by the following formula (IV): 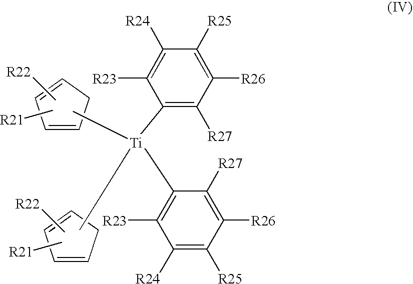
wherein each of R21 and R22 independently denotes a hydrogen atom or a methyl group; R23 denotes a fluorine atom, —CF₃ or —CF₂CH₃; and each of R24, R25, R26 and R27 independently denotes a hydrogen atom, a fluorine atom, —CF₃, —CF₂CH₃, a C₁-C₁₂ alkyl group or alkoxy group, a 6-membered carbocyclic aromatic group, or a 5- or 6-membered heterocyclic aromatic group.

7. A photocurable fixture for orthopedic surgery according to claim 6; wherein the photopolymerization initiator is bis(cyclopentadienyl)-bis(2,6-difluoro-3-(pyrrol-1-yl)phenyl)titanium.

8. A photocurable fixture for orthopedic surgery, comprising: a base material; and a photocurable resin retained in the base material, the photocurable resin containing a urethane type (meth)acrylic acid derivative oligomer obtainable by a polyisocyanate having at least three isocyanate groups, a diisocyanate having two isocyanate groups, and a (meth)acrylic acid derivative having an active hydrogen group, and a photopolymerization initiator which absorbs light within a range of 400 to 700 nm.

9. A photocurable fixture for orthopedic surgery according to claim 8; wherein the active hydrogen group of the (meth)acrylic acid derivative is either one of a hydroxy group, an amino group or a mercapto group, and the (meth)acrylic acid derivative is a (meth)acrylate or a (meth)acrylamide.

10. A photocurable fixture for orthopedic surgery according to claim 9; wherein the (meth)acrylic acid derivative is a (meth)acrylate having a hydroxy group represented by the following formula (II), 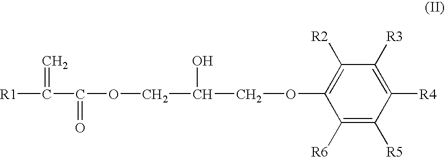
wherein each of R1 to R6 denotes a hydrogen atom or a methyl group.

11. A photocurable fixture for orthopedic surgery according to claim 8; wherein the photopolymerization initiator is a bisacylphosphine oxide type photopolymerization initiator represented by the following formula (III): 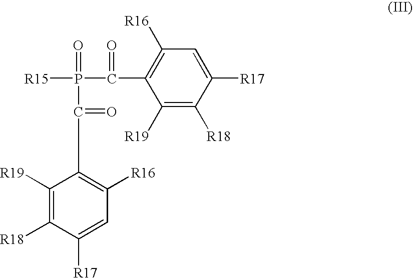
wherein R15 denotes a straight chain or branched chain C₁₋₁₂ alkyl group, a cycloalkyl group, an aryl group which may be substituted by a straight chain or branched chain C₁₋₁₂ alkyl group or a halogen atom; each of R16 and R17, which may be the same or different, denotes a hydrogen atom, a straight chain or branched chain C₁₋₁₂ alkyl group, or a straight chain or branched chain C₁₋₁₂ alkoxy group; and each of R18 and R19, which may be the same or different, denotes a hydrogen atom, or a straight chain or branched chain C₁₋₁₂ alkyl group.

12. A photocurable fixture for orthopedic surgery according to claim 11; wherein the photopolymerization initiator is bis(2,4,6-trimethylbenzoyl)phenyl phosphine oxide.

13. A photocurable fixture for orthopedic surgery according to claim 8; wherein the photopolymerization initiator is a titanocene type photopolymerization initiator represented by the following formula (IV): 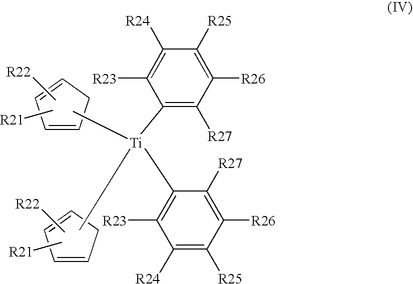
wherein each of R21 and R22 independently denotes a hydrogen atom or a methyl group; R23 denotes a fluorine atom, —CF₃ or —CF₂CH₃; and each of R24, R25, R26 and R27 independently denotes a hydrogen atom, a fluorine atom, —CF₃, —CF₂CH₃, a C₁-C₁₂ alkyl group or alkoxy group, a 6-membered carbocyclic aromatic group, or a 5- or 6-membered heterocyclic aromatic group.

14. A photocurable fixture for orthopedic surgery according to claim 13; wherein the photopolymerization initiator is bis(cyclopentadienyl)-bis(2,6-difluoro-3-(pyrrol-1-yl)phenyl)titanium.
